(19) United States
(12) Patent Application Publication
(10) Pub. No.: US 2010/0240491 A1
(43) Pub. Date: Sep. 23, 2010

(54) SYSTEM FOR VEHICLE PROPULSION HAVING AND METHOD OF MAKING SAME

(76) Inventors: Parag Vyas, Munich (DE); Yaru Mendez Hernandez, Munich (DE); Alexander Felix Fiseni, Munchen (DE)

Correspondence Address: GE TRADING & LICENSING, 1 RESEARCH CIRCLE, ATTN: BRANDON, K1 - 2A62A, NISKAYUNA, NY, 12309, US

(21) Appl. No.: 12/405,861

(22) Filed: Mar. 17, 2009

(51) Int. Cl. B60W 10/04; B60K 6/20; B23P 11/00; B60W 20/00

(52) U.S. Cl. 477/3; 180/65.21; 180/65.275; 29/428; 180/65.265

(57) ABSTRACT

A vehicle propulsion system includes a continuously variable transmission (CVT) having an input side and an output side, the CVT configured to condition an input received at the input side and to output the conditioned input at the output side. The vehicle propulsion also includes an internal combustion engine (ICE) mechanically coupled to the input side of the CVT and configured to provide the input to the CVT. The vehicle propulsion includes an electric machine (EM) mechanically coupled to the output side of the CVT, the EM configured to receive the conditioned input from the CVT.

### BACKGROUND OF THE INVENTION

The invention relates generally to electric and hybrid vehicles, and more specifically to a vehicle propulsion system having a continuously variable transmission (CVT).

As is known in the art, CVTs are capable of continuously or steplessly varying the speed of rotation of an output shaft over a range of operating speeds while an input shaft rotates. CVTs may be used in automotive applications as a substitute for conventional fixed-ratio transmissions or multi-geared automatic transmission systems. CVTs have an advantage over conventional transmissions because of their large and “continuous” transmission ratio coverage, which may range from 1:10 to 1:20 for example. In order to achieve this large range of gear ratios, such CVTs tend to be large, expensive to manufacture, and less efficient than conventional gearboxes due to additional friction between the input and output shafts, and the costs and inefficiencies increase with size. However, CVTs also minimize noticeable shifting events, provide a smoother and more comfortable ride, and allow an engine to operate at more economic operating points, thus increasing fuel efficiency of the engine compared with vehicles equipped with fixed-gear, automatic transmissions.

It would therefore be desirable to design a vehicle propulsion system that incorporates a CVT while reducing the size, cost, and inefficiencies typically associated with CVTs.

### BRIEF DESCRIPTION OF THE INVENTION

According to an aspect of the invention, a vehicle propulsion system includes a continuously variable transmission (CVT) having an input side and an output side, the CVT configured to condition an input received at the input side and to output the conditioned input at the output side. The vehicle propulsion also includes an internal combustion engine (ICE) mechanically coupled to the input side of the CVT and configured to provide the input to the CVT. Additionally, the vehicle propulsion includes an electric machine (EM) mechanically coupled to the output side of the CVT, the EM configured to receive the conditioned input from the CVT.

In accordance with another aspect of the invention, a vehicle having a vehicle propulsion system is provided. The vehicle includes a vehicle traction system, an internal combustion engine (ICE) configured to generate an ICE output, and a continuously variable transmission (CVT) having an input side and an output side, the input side mechanically coupled to the ICE and configured to receive the ICE output and output a conditioned output on the output side. The vehicle also includes an electromechanical device attached to the output side of the CVT and configured to receive the conditioned output from the CVT and deliver a vehicle propulsion system output to the vehicle traction system.

According to yet another aspect of the invention, a method of fabricating a vehicle power system includes coupling an output of an internal combustion engine (ICE) to an input side of a continuously variable transmission (CVT). The method also includes coupling an output side of the CVT to an electric machine (EM), the CVT configured to receive a power from the ICE and transfer a conditioned power to the EM and coupling an output of the EM to a vehicle traction system.

Various other features and advantages will be made apparent from the following detailed description and the drawings.

### BRIEF DESCRIPTION OF THE DRAWINGS

The drawings illustrate one preferred embodiment presently contemplated for carrying out the invention.

In the drawings:

FIG. 1 is a schematic diagram of a vehicle propulsion system according to an embodiment of the invention.

FIG. 2 is a schematic diagram of a CVT as known in the art.

### DETAILED DESCRIPTION

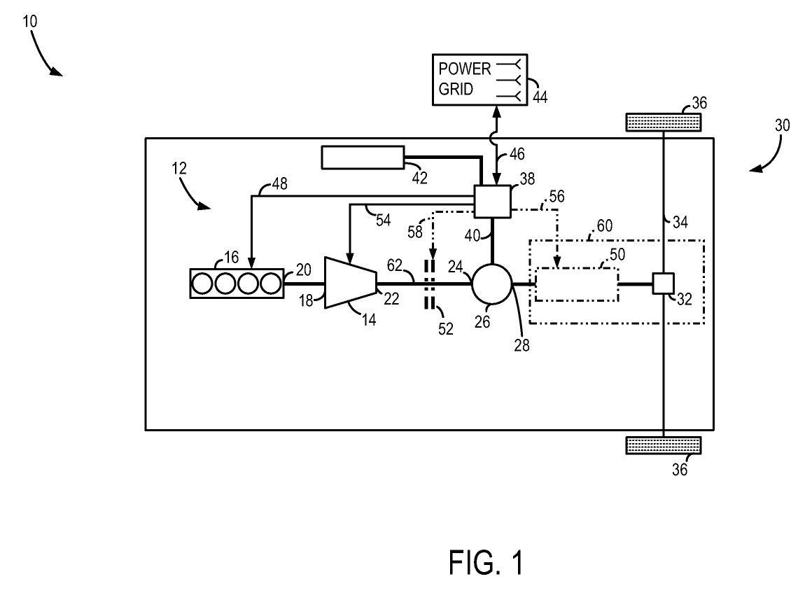

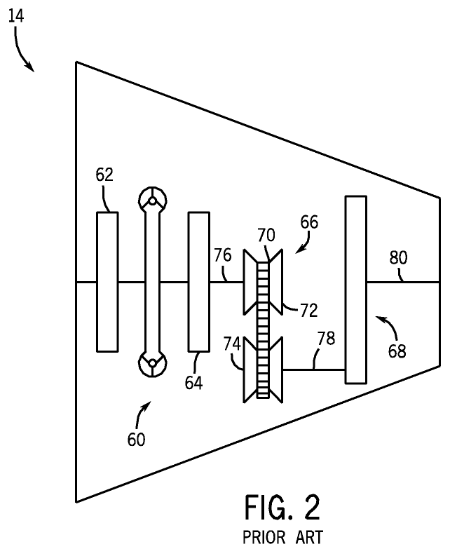

FIG. 1 illustrates an embodiment of the invention and includes a schematic of a vehicle 10 having a vehicle propulsion system 12 that incorporates a CVT 14, an exemplary embodiment of which is described with respect to FIG. 2. While a belt-driven CVT is described herein, one skilled in the art will recognize that the invention is equally applicable to any type of CVT such as, for example, a torodially-driven CVT. Vehicle propulsion system 12 includes an internal combustion engine (ICE) 16 that produces an unconditioned output. That is, ICE 16 produces an output power capable of propelling vehicle 10 via vehicle propulsion system 12 and, because of the dual requirements of high torque capability at lower cruising speeds and high speed output at higher cruising speeds, it is desirable to further condition the power output from ICE 16 to best meet the overall needs of vehicle propulsion system 12.

As shown in FIG. 1, an input side so-called high rotating or high speed side 18 of CVT 14 is coupled to an output 20 of ICE 16 and an output side so-called low rotating or low speed side 22 of CVT 14 is coupled to an input 24 of an electro-mechanical device or electric machine (EM) 26. An output 28 of EM 26 connects vehicle propulsion system 12 to a vehicle traction system 30, which includes a differential 32 connecting a traction system drive shaft 34 to wheels 36. Vehicle propulsion system 12 also includes a bidirectional controller/power convertor 38, which is electrically coupled to EM 26 via a power bus 40. Bidirectional controller 38 is configured or programmed to selectively transmit electric power between EM 26 and an energy storage unit or battery storage unit 42 to respectively power EM 26 or to charge battery storage unit 42, as needed. Battery storage unit 42 may include one or more individual batteries (not shown), such as, for example, a lead-acid battery, gel battery, nickel metal hydride battery, lithium-ion battery, Ni—Cd battery, ultracapacitor, fuel cell, and the like. Bidirectional controller 38 may, for example, permit recharging of battery storage unit 42 during regenerative braking. In another embodiment, bidirectional controller 38 is electrically connected to an electrical grid 44, such as a three-phase utility grid, for example, via a bidirectional connection 46 and is configured to selectively draw power from an electrical grid 44, such as in a “plug-in” electric vehicle, to recharge battery storage unit 42. Bidirectional controller 38 may also be configured to inject power from EM 26 to electrical grid 44. Bidirectional controller 38 is also electrically coupled to ICE 16 via control line 48 to transmit command signals thereto. During vehicle operation, bidirectional controller 38 may also transmit command signals to CVT 14, to an optional selectable fixed-ratio transmission 50 (shown in phantom), and to an optional clutch 52 (shown in phantom) via control lines 54, 56, 58 respectively, as described in detail below.

In one embodiment, CVT 14 may include a gear range of 1:10-1:20 or any other gear relation or ratio, depending on the design and torque requirements. However, according to an exemplary embodiment of the invention, vehicle propulsion system 12 may include an optional fixed-ratio transmission 50 (shown in phantom). In one embodiment, fixed-ratio transmission 46 and differential 32 may be integrated into a transaxle 60. Fixed-ratio transmission 50 is positioned between output side 28 of EM 26 and vehicle traction system 30. Fixed-ratio transmission 50 may include a single fixed gear ratio, for example, 1:10, or be configured with several selectable fixed gear ratios, for example, 1:1, 1:2, and 1:10. The inclusion of a fixed-ratio transmission, such as transmission 50 having a 1:10 ratio, with CVT 14, thus enables CVT 14 to carry a portion of the gear ratio requirements, such as 1:1-1:2, and transmission 50 can thus carry the remainder of the gear ratio requirements. As such, in combination, CVT 14 and fixed-ratio transmission 50 may obtain a gear ratio range of 1:10-1:20, which improves overall efficiency of vehicle propulsion system 12 by introducing a more efficient fixed-ratio transmission 50 and enabling CVT 14 to be more compact and, thus, less costly than a stand-alone CVT that would carry the entire gear ratio range of 1:10-1:20.

In operation, the start-up gear ratio of CVT 14 (or, alternatively, the effective start-up gear ratio of the combination of CVT 14 and fixed transmission 50, if used) is set at a higher fixed gear ratio than the startup gear ratio of a conventional fixed-ratio transmission. By coupling CVT 14 (or, alternatively, the combination of CVT 14 and fixed transmission 50, if used) to ICE 16, the torque output of ICE 16 at startup may be amplified. Thus, the size and/or power rating of ICE 16 may be reduced when compared with an ICE that alone would provide the same startup torque. Thus, the cost and/or overall dimensions of vehicle propulsion system 12 may be reduced.

During vehicle operation, controller 38 increases the operating speed of ICE 16 until the operating speed achieves operation within a desired speed range. Controller 38 then selectively controls ICE 16, EM 26, CVT 14, and fixed-ratio transmission 50 (if used) to optimize vehicle operation. Specifically, controller 38 monitors real-time vehicle operating conditions to determine a desired propulsion system output to be delivered to the vehicle traction system 30. To determine the desired propulsion system output, controller 38 may be programmed, for example, to monitor a real-time vehicle acceleration requirement, including driver input information via an acceleration pedal for example, to determine a desired torque output of vehicle propulsion system 12 and/or to monitor a real-time vehicle cruising speed requirement to determine a desired speed output of vehicle propulsion system 12. Controller 38 operates ICE 16 within the desired speed range, which may be a narrower range of speeds than the range of operating speeds for a similar ICE operating as a stand-alone unit. By selectively controlling the operating speed of ICE 16, controller 38 may operate ICE 16 within a range of speeds that minimizes fuel consumption.

Based on the desired propulsion system output, controller 38 operates ICE 16 and CVT 14 to produce and deliver a conditioned output to vehicle propulsion system 12. First, controller 38 selectively operates CVT 14 to condition an output from ICE 16 and deliver a conditioned output to EM 26. Specifically, controller 38 controls CVT 14 to operate within a continuous range of gear ratios, such as, for example, between 1:2 and 1:1, to condition the output from ICE 16 and produce a variable power output as needed by vehicle traction system 30. Controller 38 may, for example, operate CVT 14 within a desired gear-ratio range that maximizes an operating efficiency of the CVT 14 and/or the vehicle propulsion system 12. Controller 38 may be further programmed to selectively control the gear ratio of CVT 14, and, therefore, condition the output of ICE 16 according to an operator-selected performance mode such as a “sport mode” that maximizes acceleration performance, or such as an “economy mode” that minimizes fuel consumption of vehicle propulsion system 12, as examples.

As described above, controller 38 is programmed to monitor vehicle operation and control CVT 14 based on a torque or speed output desired by the vehicle power system. Thus, for example, at vehicle start-up, controller 38 may operate CVT 14 to selectively amplify the torque output from ICE 16 and deliver the conditioned output to EM 26. As such, ICE 16 and CVT 14 may be controlled together to deliver an equivalent output torque as a larger stand-alone ICE with a higher power rating. Alternatively, during vehicle operation, for example, controller 38 may operate CVT 14 to increase the rotational speed of the output of ICE 16 while delivering the vehicle power requirements. Because CVT 14 may be controlled to increase the rotational speed of propulsion system drive shaft 62 prior to input 24 of EM 26, vehicle propulsion system 12 may be designed with a smaller EM (i.e., an EM having a smaller power or torque rating) than would otherwise be needed in a vehicle propulsion system without a CVT. As such, EM 26 and CVT 14 can be controlled together to deliver equivalent output power to vehicle traction system 30 as a larger stand-alone EM having a higher power rating.

Controller 38 also continuously monitors the actual output of vehicle propulsion system 12 versus the desired real-time vehicle propulsion system output to determine if any additional output is needed from vehicle propulsion system 12. If additional output (e.g., increased torque or increased output speed) is needed, controller 38 selectively operates EM 26 to produce the needed output, which may include power from EM 26 to add additional boost to the power output of ICE 16. Controller 38 may also be programmed to monitor for transient changes in the propulsion system instantaneous or real-time output requirement due to, for example, an acceleration increase or change in road topology. Based on any changes in the real-time propulsion system output requirement, controller 38 may selectively control EM 26 to increase rotational speed or output torque and, thus, EM 26 may provide the additional output to meet the real-time output requirement.

In embodiments wherein vehicle propulsion system 12 includes fixed transmission 50, controller 38 operates CVT 14 and fixed transmission 50 to recondition the output from CVT 14 and deliver the reconditioned output to differential 32 of vehicle traction system 30. Controller 38 selects a combined or effective gear ratio for both CVT 14 and fixed transmission 50 such that the reconditioned output meets the desired propulsion system output. For example, if fixed transmission 50 is configured with a 1:10 gear ratio and controller 38 determines that a 1:20 ratio is needed to meet the desired propulsion system output, controller 38 will operate the CVT 14 at a gear ratio of 1:2. The gear ratio of CVT 14 may also be adjusted (e.g., between 1:1 and 1:2) to meet any changes in an instantaneous acceleration requirement. Because the conditioned output of CVT 14 is reconditioned by fixed transmission 50 to produce the desired propulsion system output, the combination of CVT 14 and fixed transmission 50 allows CVT 14 to be operated at a lower gear ratio than a stand-alone CVT, allowing for a smaller, less complex, less expensive, and more efficient CVT unit.

Furthermore, use of fixed transmission 50 in combination with CVT 14 minimizes the frictional inefficiencies inherent in a stand-alone CVT. By coupling fixed transmission 50 between CVT 14 and vehicle traction system 30, CVT 14 may be locked at an optimal fixed gear ratio when the vehicle is cruising. Coupling fixed transmission 50 between the output 28 of EM 26 and vehicle traction system 30 benefits EM 26 as well. Specifically, controller 38 may operate fixed transmission 50 to condition the output of EM to produce an increased torque output. Thus, fixed transmission 56 and EM 26 may be controlled together to produce an equivalent torque output as a stand-along EM with a higher power rating that the power rating of EM 26.

When EM 26 is not operating to provide transient response torque, the EM 26 may be used for energy storage by acting as a generator. That is, controller 38 may be configured to monitor a charge status of battery storage unit 42 and direct a power output from EM to 26 battery storage unit 42, as needed. Controller 38 may also selectively decouple ICE 16 and CVT 14 from EM 26 via clutch 52 to allow for electric drive of vehicle propulsion system 12, such as in an operating mode where electric drive may produce a more efficient output. Decoupling ICE 16 and CVT 14 also allows for electric driving of vehicle 10 in a reverse direction.

FIG. 2 illustrates a known embodiment of a CVT 14. CVT 14 includes several main components: a launching device 60, an actuation system 62, a drive-neutral-reverse (DNR) set 64, a variator 66, and an output gearing 68. Launching device 60 typically includes a torque converter, which is used at vehicle startup. After vehicle startup, the torque converter may be locked by engaging an internal clutch. The DNR set 64 enables a vehicle to be shifted between neutral, forward, and reverse. DNR set 64 typically includes a planetary gear set and a set of clutches, which are selectively engaged to shift the vehicle between forward and reverse and selectively disengaged to place the transmission in neutral. Variator 66 comprises a belt 70 clamped between two pairs of conical sheaves 72, 74 with one pair of sheaves 72 mounted on an input 76 of variator 66 and the other pair of sheaves 74 mounted on an output 78 of variator 66. Although a belt-driven variator is described herein, one skilled in the art will recognize that CVT 74 may alternatively comprise another type of variator design such as, for example, a toroidal or roller-based design.

The gear ratio of CVT 14 is determined by adjusting the distance between each pair of sheaves 72, 74. The actuation system 62 typically uses hydraulics to set and maintain the desired gear ratio. To transmit the CVT output to a vehicle traction system, an output gearing 68, for example, an elliptical gearset, is positioned between output 78 of variator 66 and an output 80 of CVT 14. In operation, CVT 74 is able to condition an input power by selectively varying the gear ratio of CVT 74, thus producing an output having an altered torque.

A technical contribution for the disclosed method and apparatus is that it provides for a controller-implemented technique for operating a vehicle propulsion system having a CVT.

According to one embodiment of the invention, a vehicle propulsion system includes a continuously variable transmission (CVT) having an input side and an output side, the CVT configured to condition an input received at the input side and to output the conditioned input at the output side. The vehicle propulsion also includes an internal combustion engine (ICE) mechanically coupled to the input side of the CVT and configured to provide the input to the CVT. Additionally, the vehicle propulsion includes an electric machine (EM) mechanically coupled to the output side of the CVT, the EM configured to receive the conditioned input from the CVT.

In accordance with another embodiment of the invention, a vehicle having a vehicle propulsion system is provided. The vehicle includes a vehicle traction system, an internal combustion engine (ICE) configured to generate an ICE output, and a continuously variable transmission (CVT) having an input side and an output side, the input side mechanically coupled to the ICE and configured to receive the ICE output and output a conditioned output on the output side. The vehicle also includes an electromechanical device attached to the output side of the CVT and configured to receive the conditioned output from the CVT and deliver a vehicle propulsion system output to the vehicle traction system.

In accordance with yet another embodiment of the invention, a method of fabricating a vehicle power system includes coupling an output of an internal combustion engine (ICE) to an input side of a continuously variable transmission (CVT). The method also includes coupling an output side of the CVT to an electric machine (EM), the CVT configured to receive a power from the ICE and transfer a conditioned power to the EM and coupling an output of the EM to a vehicle traction system.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed is:

1. A vehicle propulsion system comprising:
a continuously variable transmission (CVT) having an input side and an output side, the CVT configured to condition an input received at the input side and to output the conditioned input at the output side;
an internal combustion engine (ICE) mechanically coupled to the input side of the CVT and configured to provide the input to the CVT; and
an electric machine (EM) mechanically coupled to the output side of the CVT, the EM configured to receive the conditioned input from the CVT.

2. The vehicle propulsion system of claim 1 further comprising a vehicle traction system configured to receive a vehicle propulsion system output from the EM.

3. The vehicle propulsion system of claim 2 further comprising a fixed-ratio transmission coupled to an output of the EM and configured to:
receive the vehicle propulsion system output from the EM;
modify the desired vehicle propulsion system output; and
deliver the modified vehicle propulsion system output to the vehicle traction system.

4. The vehicle propulsion system of claim 3 wherein the fixed-ratio transmission comprises one of a single fixed gear ratio and a plurality of selectable fixed gear ratios.

5. The vehicle propulsion system of claim 2 wherein the vehicle traction system comprises a transaxle coupled to an output of the EM.

6. The vehicle propulsion system of claim 1 further comprising a clutch coupled between the output side of the CVT and the EM and configured to selectively disengage the output side of the CVT from the EM.

7. The vehicle propulsion system of claim 1 further comprising a bidirectional controller configured to determine a desired vehicle propulsion system output.

8. The vehicle propulsion system of claim 7 wherein the bidirectional controller is configured to selectively operate the EM, the ICE, and the CVT based on the desired vehicle propulsion system output.

9. The vehicle propulsion system of claim 7 further comprising an energy storage unit having at least one battery, the vehicle propulsion system configured to selectively operate the bidirectional controller to:
draw electric power from the at least one battery and inject the electric power to the EM; and
draw electric power from the EM to charge the battery.

10. The vehicle propulsion system of claim 7 further comprising a bidirectional connection between the bidirectional controller and a power grid, wherein the bidirectional connection allows the bidirectional controller to selectively draw or inject electrical energy to the power grid.

11. A vehicle having a vehicle propulsion system, the vehicle comprising:
a vehicle traction system;
an internal combustion engine (ICE) configured to generate an ICE output;
a continuously variable transmission (CVT) having an input side and an output side, the input side mechanically coupled to the ICE and configured to receive the ICE output and output a conditioned output on the output side;
an electromechanical device attached to the output side of the CVT and configured to:
receive the conditioned output from the CVT; and
deliver a vehicle propulsion system output to the vehicle traction system.

12. The vehicle of claim 11 further comprising a controller configured to:
operate the ICE to produce the ICE output;
operate the CVT to condition the ICE output;
monitor vehicle operating conditions to determine the desired vehicle propulsion output; and
control the electromechanical device to deliver the desired vehicle propulsion output to the vehicle traction system.

13. The vehicle of claim 12 wherein the controller is further configured to operate the ICE within a desired speed range to produce the ICE output.

14. The vehicle of claim 13 wherein the controller is further configured to select the desired speed range to maximize an operating efficiency of the ICE.

15. The system of claim 12 wherein the controller is further configured to operate a clutch to selectively disengage the modified ICE output from the input of the electromechanical device.

16. The system of claim 15 wherein the controller is further configured to operate the electromechanical device to deliver the desired vehicle propulsion output when the ICE and CVT are disengaged.

17. The system of claim 12 wherein the controller is further configured to operate a fixed-ratio transmission to recondition the desired vehicle propulsion output, the fixed-ratio transmission coupled to an output of the electromechanical device.

18. The system of claim 12 wherein the controller is further configured to control the CVT to operate within a desired gear-ratio range, wherein the desired gear-ratio range maximizes an operating efficiency of the vehicle power system.

19. The system of claim 12 wherein the controller is further configured to:
operate the CVT at a fixed gear ratio for a first time period; and
operate the CVT at a variable gear ratio for a second time period.

20. A method of fabricating a vehicle power system comprising:
coupling an output of an internal combustion engine (ICE) to an input side of a continuously variable transmission (CVT);
coupling an output side of the CVT to an electric machine (EM), the CVT configured to receive a power from the ICE and transfer a conditioned power to the EM; and
coupling an output of the EM to a vehicle traction system.

21. The method of claim 20 wherein coupling the output of the EM to the vehicle traction system comprises coupling the output of the EM to the vehicle traction system via a differential.

22. The method of claim 21 wherein coupling the output of the EM to the vehicle traction system via the differential comprises coupling the output of the EM to an input side of a fixed transmission and coupling an output side of the fixed transmission to the differential.

23. The method of claim 20 further comprising:
coupling a battery storage unit to the ICE; and
configuring the ICE to deliver a charging power to the battery storage unit via the CVT.
